(19) United States
(12) Patent Application Publication
(10) Pub. No.: US 2026/0018185 A1
(43) Pub. Date: Jan. 15, 2026

(54) DEEP REINFORCEMENT ACTIVE MACHINE LEARNING SYSTEM FOR AUDIO EVENT DETECTION AND CLASSIFICATION

(71) Applicant: Robert Bosch GmbH, Stuttgart (DE)

(72) Inventors: Ana Elisa MENDEZ MENDEZ, Brooklyn, NY (US); Shabnam GHAFFARZADEGAN, Livermore, CA (US); Samarjit DAS, Wexford, PA (US)

(21) Appl. No.: 18/768,409

(22) Filed: Jul. 10, 2024

(51) Int. Cl. G10L 25/78; G10L 25/30

(52) U.S. Cl. CPC G10L 25/78; G10L 25/30

(57) ABSTRACT

Active machine learning systems for anomalous event detection and classification. Initial samples from an industrial environment may be received and labeled. Initially, a training pool of audio samples may be labeled. These labeled samples may be used to train an audio event classifier to detect and categorize sounds. Environment states may be calculated using outputs from the classifier. A batch of audio samples may then selected from an unlabeled pool for annotation, guided by a reinforcement learning agent. These selected samples may be annotated and added to the labeled training pool. The classifier may be retrained with this updated pool. Rewards may be calculated for each of the annotated samples based on their annotations. The environment states may be updated using the retrained classifier, and the exploration-exploitation parameter of the reinforcement learning agent may be adjusted. The reinforcement learning agent may be retrained using the updated environment states and rewards.

### TECHNICAL FIELD

Aspects of the disclosure generally relate to machine learning systems using deep reinforcement learning techniques for audio event detection and classification.

### BACKGROUND

Obtaining labeled audio data typically involves manual annotation by human experts, which is a slow and expensive process. While this cost may be justified if the labeled data can be reused for different tasks, in many real-world applications the classes of interest or acoustic conditions frequently change over time. Continuously relabeling data to accommodate these changes can become prohibitively expensive.

Furthermore, certain applications like anomaly detection often involve rare events, where the classes of interest constitute only a small percentage of the total data. Finding and labeling these rare instances to train a model is highly inefficient.

### SUMMARY

In one or more illustrative examples, an active machine learning method for audio event detection and classification may comprise initializing a labeled training pool with audio samples. An audio event classifier, possibly a deep learning model, may be used to train on these labeled samples. Environment states for each sample may be calculated based on outputs from the classifier, potentially using logit combined with softmax or sigmoid outputs. A reinforcement learning agent, which may use a deep Q-network algorithm, selects a batch from an unlabeled pool for annotation. This batch may be annotated and added to the training pool. The classifier may then retrained with the newly updated pool. A reward for each sample in the batch may be computed post-annotation, based on the effectiveness of the annotations, with positive rewards assigned for correcting misclassifications. The environment states may be updated with the retrained classifier, and an exploration-exploitation parameter within the reinforcement learning agent may be modified. The reinforcement learning agent may be retrained based on the updated states and computed rewards. This method further includes initializing the agent's policy using transfer learning from a related audio event detection task. The audio samples may be represented using mel-frequency cepstral coefficients or log-mel spectrograms.

In a system aspect, an illustrative example for training a model in audio event detection includes a memory that stores a labeled training pool of audio samples and an audio event classifier trained on this pool. A reinforcement learning agent, configured to select audio samples from an unlabeled pool for annotation, may be included. A processor may be configured to calculate environment states for each audio sample using outputs from the audio event classifier, add the annotated batch of audio samples to the labeled training pool, and retrain the audio event classifier using the updated labeled training pool. The processor may also be configured to calculate a reward for each audio sample in the annotated batch based on the annotation, update the environment states using the retrained audio event classifier, update an exploration-exploitation parameter of the reinforcement learning agent, and retrain the reinforcement learning agent using the updated environment states and rewards. The system may utilize a deep learning model for the classifier and a deep Q-network algorithm for the agent. The agent's action space may offer a binary choice for annotation requests, and a positive reward may be allocated for annotations correcting a misclassification.

In another example, a non-transitory computer-readable medium may comprise instructions that, when executed by a processor, facilitate an active learning method for audio event detection and classification. The method may include initializing and updating a labeled training pool with audio samples, training and retraining an audio event classifier, and calculating environment states based on the classifier's outputs. The method may also include selecting and annotating audio samples using a reinforcement learning agent, retraining the reinforcement learning agent with updated environment states and rewards, and updating the agent's exploration-exploitation parameter. These operations may be carried out using a deep learning model for the classifier and a deep Q-network algorithm for the agent, with combined logit and softmax or sigmoid outputs for environment state determinations. The action space for the agent includes a binary decision-making process on whether to request annotations, with a positive reward given for corrective annotations on misclassifications.

### BRIEF DESCRIPTION OF THE DRAWINGS

FIG. 1 illustrates an example agent-environment interaction in reinforcement learning;

FIG. 2 illustrates an example process for performing active learning for audio event detection and classification; and

FIG. 3 illustrates an example computing device for performing active learning for anomalous event detection and classification.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure describes, in one or more embodiments, a deep reinforcement active machine learning system and method for audio event detection and classification. The system may include three components: an audio event classifier, a reinforcement learning query strategy module, and a few-shot adaptation module. These components cooperate to iteratively improve the audio event detection model while minimizing the number of labeled samples required.

The audio event classifier may be a deep learning model, such as a convolutional neural network (CNN), that takes an audio signal as input and predicts the corresponding event class. The classifier may be initially trained on a small labeled dataset using supervised learning techniques. The choice of model architecture depends on the specific audio domain and task complexity. For example, a CNN with a VGGish architecture (Hershey et al., 2017) may be used for audio classification. The output of the classifier may include not only the predicted class probabilities but also intermediate features and model uncertainty estimates. These additional outputs are used by the query strategy module to assess the informativeness of each unlabeled sample. The output of the classifier may include not only the predicted class probabilities but also logit outputs and softmax or sigmoid outputs. These outputs are used to calculate the environment states for the reinforcement learning agent.

In one or more embodiments, the query strategy module is responsible for selecting the most informative samples to label at each iteration of the active learning process. In one or more embodiments, the machine learning system learns a query strategy using reinforcement learning. The query strategy may be parameterized by a deep Q-network (DQN) (Mnih et al., 2015), which takes the current state of the audio event classifier and the unlabeled pool as input, and outputs the expected value of querying each unlabeled sample. The state representation is determined by concatenating the logit outputs of the audio event classifier with softmax or sigmoid outputs. This combined representation may capture both the raw model outputs and the normalized class probabilities, providing a comprehensive view of the classifier's decision-making process. The state representation may include features such as the classifier's prediction entropy, the diversity of the labeled set, and the similarity between the unlabeled sample and the labeled set. The DQN may be trained using a reward signal that measures the improvement in the audio event classifier's performance after labeling each queried sample. The reward function can be customized based on the specific evaluation metric, such as accuracy, F1-score, or area under the precision-recall curve.

During the active learning process, the DQN may suggest a batch of samples to label at each iteration, based on its current estimate of the action values. The batch size may be a hyperparameter that controls the trade-off between the frequency of model updates and the efficiency of annotation. The selected samples may then be labeled by human annotators and added to the training set for the audio event classifier.

In real-world audio event detection applications, the set of relevant event classes may change over time as new types of events emerge. To address this challenge, the machine learning system of one or more embodiments includes a few-shot adaptation module that enables the audio event classifier to learn new classes with only a few labeled examples. The few-shot adaptation module uses a meta-learning approach, such as Model-Agnostic Meta-Learning (MAML) (Finn et al., 2017), to train the audio event classifier to adapt quickly to new tasks. During meta-training, the module simulates the few-shot learning scenario by constructing a series of tasks, each consisting of a small support set of labeled examples and a query set of unlabeled examples. The classifier may be trained to minimize the loss on the query set after a few gradient steps on the support set. At test time, when a new event class is introduced, the few-shot adaptation module can fine-tune the audio event classifier using only a few labeled examples of the new class. This allows the system to expand its detection capabilities without extensive retraining.

The deep reinforcement active machine learning systems of one or more embodiments operate in an iterative manner, alternating between querying labels, updating the audio event classifier, and adapting to new classes. The system workflow begins by initializing the audio event classifier with a small labeled dataset and training it using supervised learning. The query strategy DQN may then be initialized with random parameters. The system then enters a loop where it uses the query strategy DQN to select a batch of informative samples from the unlabeled pool, labels the selected samples using human annotators, updates the audio event classifier using the expanded labeled dataset, evaluates the audio event classifier on a validation set, computes the reward signal for the query strategy DQN, and updates the query strategy DQN using the computed reward and the DQN algorithm. This loop may continue until a stopping criterion is met, such as reaching a target performance level or exhausting a budget for annotation. If a new event class is introduced, the few-shot adaptation module may be used to fine-tune the audio event classifier with a few labeled examples of the new class. The trained audio event classifier may be deployed for real-time event detection on streaming audio data.

The system hyperparameters, such as the batch size for querying, the architecture of the audio event classifier and the query strategy DQN, and the meta-learning algorithm for few-shot adaptation, can be optimized based on the specific application domain and the available computational resources. For example, the batch size can be adjusted to balance the trade-off between the frequency of model updates and the efficiency of annotation. A larger batch size allows for more efficient labeling but may result in less frequent updates to the audio event classifier. The architecture of the audio event classifier can be tailored to the complexity of the audio events being detected, with deeper and more sophisticated models used for more challenging tasks. Similarly, the architecture of the query strategy DQN can be designed to capture the relevant features of the audio event detection problem, such as the diversity of the labeled set and the similarity between unlabeled samples and labeled samples. The choice of meta-learning algorithm for few-shot adaptation can also impact the system's performance, with more advanced algorithms like MAML potentially enabling faster adaptation to new event classes.

To evaluate the proposed deep reinforcement active learning system, experiments can be conducted on benchmark audio event detection datasets, such as UrbanSound8K (Salamon et al., 2014), ESC-50 (Piczak, 2015), and AudioSet (Gemmeke et al., 2017). The system's performance can be compared to baseline methods, including random sampling, uncertainty sampling, diversity sampling, and batch active learning. The evaluation metrics can include the accuracy, F1-score, and area under the precision-recall curve, as well as the number of labeled samples required to reach a target performance level. In addition to the overall performance, ablation studies can be conducted to assess the contribution of each component of the proposed system, such as the reinforcement learning query strategy and the few-shot adaptation module. The sensitivity of the system to hyperparameters, such as the batch size and the reward function, can also be analyzed.

The experimental results can demonstrate the effectiveness of the proposed deep reinforcement active learning approach in reducing annotation costs while maintaining high detection accuracy for audio event detection tasks. For example, the system may achieve comparable or better performance than baseline methods while requiring significantly fewer labeled samples. The ablation studies can provide insights into the relative importance of each component of the system, such as the contribution of the reinforcement learning query strategy to the overall performance improvement. The sensitivity analysis can help identify the optimal hyperparameter settings for a given application domain and computational budget.

The machine learning system of one or more embodiments may have one or more technological advantages over existing approaches to audio event detection. First, by learning an optimal query strategy using reinforcement learning, the system can adapt to the characteristics of the audio data and the detection task, instead of relying on fixed heuristics. This can lead to more efficient and effective labeling, as the system can identify the most informative samples based on the current state of the audio event classifier and the unlabeled pool. Second, by leveraging few-shot learning, the system can quickly adapt to new event classes with only a few labeled examples, enabling scalable and flexible detection in dynamic environments. This may be of particular importance in real-world applications where the set of relevant event classes may change over time, such as in environmental monitoring or surveillance. Third, the system has the potential to achieve state-of-the-art performance on benchmark audio event detection datasets while significantly reducing the cost of annotation. This can make audio event detection more practical and cost-effective in a wide range of technical applications.

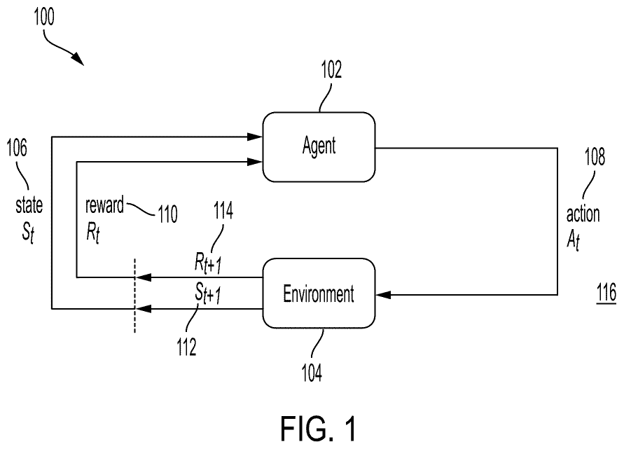

FIG. 1 shows an agent-environment interaction in reinforcement learning 100, which is a core concept in reinforcement learning and plays a role in the deep reinforcement active learning system for audio event detection and classification. The Agent 102 in this context is the reinforcement learning query strategy module, which is responsible for selecting the most informative samples to label at each iteration of the active learning process. The Environment 104 represents the audio event detection task, which includes the audio event classifier, the unlabeled pool of audio samples, and the evaluation metrics.

The state Sₜ 106 that the Agent 102 receives from the Environment 104 at each time step t is a representation of the current status of the audio event detection task. This state can include various features such as the classifier's prediction entropy, the diversity of the labeled set, and the similarity between the unlabeled samples and the labeled samples. These features provide the Agent 102 with the necessary information to make informed decisions about which samples to select for labeling.

Based on the state Sₜ 106, the Agent 102 selects an action At 108, which corresponds to querying a batch of samples for labeling. The size of this batch is a hyperparameter that can be adjusted to balance the trade-off between the frequency of model updates and the efficiency of annotation. The choice of action is determined by the policy of the Agent 102, which is parameterized by a deep Q-network (DQN) in the proposed system. The DQN takes the state as input and outputs the expected value of querying each unlabeled sample.

After the selected samples are labeled by human annotators and added to the training set, the audio event classifier may be updated, and the evaluation metrics are computed on a validation set. These metrics serve as the reward Rₜ 110 for the Agent, indicating the improvement in the classifier's performance resulting from the selected samples. The reward function can be customized based on the specific evaluation metric, such as accuracy, F1-score, or area under the precision-recall curve.

The Environment then transitions to a new state Sₜ₊₁ 112 and reward state Rₜ₊₁ 114, which reflects the updated status of the audio event detection task after the classifier has been trained on the newly labeled samples. This new state is fed back to the Agent, allowing it to adapt its policy based on the observed impact of its previous actions.

This iterative interaction between the Agent and the Environment enables the system to learn an optimal query strategy that adapts to the characteristics of the audio data and the detection task. By continuously updating its policy based on the observed states, actions, and rewards, the Agent can effectively identify the most informative samples to label, reducing the annotation cost while maintaining high detection accuracy.

The exploration-exploitation trade-off is another important aspect of reinforcement learning that is relevant to the machine learning system of one or more embodiments. The Agent balances the exploration of new actions (e.g., querying diverse samples) with the exploitation of actions that have previously led to high rewards (e.g., querying samples similar to those that have improved the classifier's performance). This trade-off may be managed by an exploration strategy, such as epsilon-greedy or softmax exploration, which determines the probability of selecting a random action versus the action with the highest estimated value.

The exploration strategy can be adapted to the specific requirements of the audio event detection task. For example, the Agent can start with a high exploration rate to gather diverse samples and gradually reduce the exploration rate as the classifier's performance improves. Additionally, the Agent can leverage prior knowledge from related audio event detection tasks to guide its exploration, as mentioned in the transfer learning aspect of the disclosure.

The few-shot adaptation module can also be integrated into the reinforcement learning framework. When a new event class is introduced, the Agent can select samples from the new class to be labeled and fine-tune the audio event classifier using the few-shot adaptation module. The performance of the adapted classifier on the new class can then be incorporated into the reward function, encouraging the Agent to prioritize samples from the new class that are most informative for the few-shot adaptation process.

By combining deep learning, reinforcement learning, and few-shot learning techniques, the machine learning system of one or more embodiments can effectively learn an optimal query strategy for audio event detection and classification, reducing the annotation cost while maintaining high technical performance and adaptability to new event classes. The agent-environment interaction, as illustrated in FIG. 1, enables the machine learning systems of one or more embodiments to continuously improve their query strategies based on the observed impact of its actions on the audio event detection task.

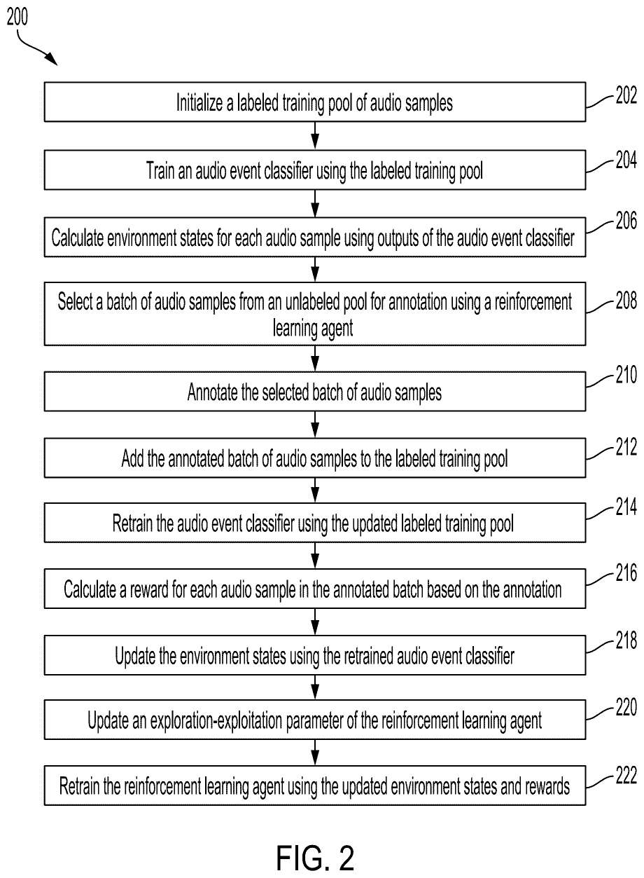

FIG. 2 illustrates a process 200 of deep reinforcement active machine learning system for audio event detection and classification according to one or more embodiments. The process begins with initializing a labeled training pool of audio samples as set forth in step 202. This initial pool may be created through unsupervised learning techniques, such as clustering or anomaly detection, applied to an unlabeled dataset. Next, an audio event classifier, such as a deep machine learning model (e.g., CNN), is trained using the labeled training pool as set forth in step 204. The classifier learns to predict the event classes from the input audio features.

The machine learning system may then calculate environment states for each audio sample using the outputs of the trained audio event classifier as set forth in step 206. These states are determined by concatenating the logit outputs of the audio event classifier with the softmax or sigmoid outputs. The concatenated outputs capture information about the classifier's confidence, the diversity of the labeled set, and the similarity between labeled and unlabeled samples. The state representation serves as input to the reinforcement learning agent. These states capture information about the classifier's confidence, the diversity of the labeled set, and the similarity between labeled and unlabeled samples. The state representation serves as input to the reinforcement learning agent. The reinforcement learning agent, parameterized by a deep Q-network (DQN), selects a batch of audio samples from the unlabeled pool for annotation 208. The batch size may be a hyperparameter that balances the trade-off between annotation efficiency and model update frequency.

The audio samples may be represented as mel-frequency cepstral coefficients or log-mel spectrograms, which are features used in audio analysis and classification tasks. These features capture the spectral characteristics of the audio signal and provide a compact representation that is suitable for input to deep learning models used in the process 200.

The selected batch of audio samples is annotated by human experts as set forth in step 210, providing ground truth labels for the events of interest. These annotated samples are then added to the labeled training pool as set forth in step 212, expanding the dataset for the audio event classifier. The audio event classifier is retrained using the updated labeled training pool as set forth in step 214. This iterative training process allows the classifier to improve its performance by learning from the newly annotated samples. A reward is calculated for each audio sample in the annotated batch based on the annotation as set forth in step 216. The reward measures the informativeness of the sample, considering factors such as the classifier's prediction accuracy and the sample's similarity to other labeled samples.

The environment states are updated using the retrained audio event classifier as set forth in step 218. Step 218 ensures that the state representation reflects the current performance and knowledge of the classifier. An exploration-exploitation parameter of the reinforcement learning agent is updated as set forth in step 220. This parameter controls the balance between exploring new actions (e.g., selecting diverse samples) and exploiting actions that have led to high rewards in the past. Finally, the reinforcement learning agent is retrained using the updated environment states and rewards as set forth in step 222. This allows the agent to improve its sample selection strategy based on the feedback received from the annotation process.

The process 200 includes an audio event classifier and a reinforcement learning agent. The classifier may predict the event classes from the audio input, while the agent selects the most informative samples for annotation. The interaction between these components enables the system to iteratively improve its performance with minimal human annotation effort. The process 200 continues iteratively until a stopping criterion is met, such as reaching a target performance level or exhausting the annotation budget. At each iteration, the system leverages the knowledge gained from the newly annotated samples to refine the audio event classifier and adapt the sample selection strategy. If a new event class is introduced, the system can utilize a few-shot adaptation module to fine-tune the audio event classifier using a small number of labeled examples from the new class. This allows the machine learning system of one or more embodiments to quickly extend its detection capabilities without extensive retraining.

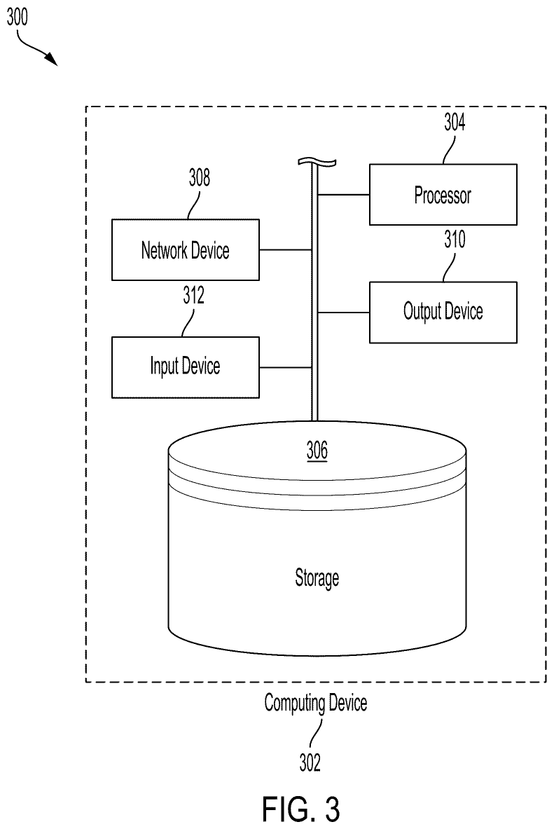

FIG. 3 illustrates an example 300 of a computing device 302 for implementing the deep reinforcement active machine learning system for audio event detection and classification of one or more embodiments. As shown, the computing device 302 includes a processor 304 that is operatively connected to a memory 306, a network device 308, an output device 310, and an input device 312. It should be noted that this is merely an example, and computing devices 302 with more, fewer, or different components may be used.

The processor 304 may include one or more integrated circuits that implement the functionality of a central processing unit (CPU) and/or graphics processing unit (GPU). In some examples, the processors 304 are a system on a chip (SoC) that integrates the functionality of the CPU and GPU. The SoC may optionally include other components such as, for example, the memory 306 and the network device 308 into a single integrated device. In other examples, the CPU and GPU are connected to each other via a peripheral connection device such as peripheral component interconnect (PCI) express or another suitable peripheral data connection. In one example, the CPU is a commercially available central processing device that implements an instruction set such as one of the x86, ARM, Power, or microprocessor without interlocked pipeline stage (MIPS) instruction set families.

Regardless of the specifics, during operation the processor 304 executes stored program instructions that are retrieved from the memory 306. The stored program instructions include software that controls the operation of the processors 304 to perform the deep reinforcement active learning process described herein. The processor 304 can execute complex algorithms involved in training the audio event classifier, calculating environment states, selecting samples for annotation using the reinforcement learning agent, updating the classifier and the agent, and performing few-shot adaptation. The memory 306 may include both non-volatile memory and volatile memory devices. The non-volatile memory includes solid-state memories, such as NOR and NAND flash memory, magnetic and optical storage media, or any other suitable data storage device that retains data when the system is deactivated or loses electrical power. The volatile memory includes static and dynamic random-access memory (RAM) that stores program instructions and data during operation of the deep reinforcement active learning system. The network device 308 can be in communication with sensor systems to receive audio data and store it in the memory 306. Alternatively, the memory 406 may already contain audio data from the sensor systems.

The GPU may include hardware and software for processing and display of the audio data, intermediate features, and classification results. The output device 310 is configured to present the results of the audio event detection and classification process in an understandable format for human operators. The output device 310 may include a graphical or visual display device, such as an electronic display screen, projector, printer, or any other suitable device that reproduces a graphical display. As another example, the output device 310 may include an audio device, such as a loudspeaker or headphone.

The input device 312 may include various devices that enable the computing device 302 to receive control input from users. The input device 312 enables users to interact with the computing device, to configure the deep reinforcement active learning process, annotate samples, and refine operational parameters based on performance evaluations. Examples of suitable input devices that receive human interface inputs may include keyboards, mice, trackballs, touchscreens, voice input devices, graphics tablets, and the like.

The network devices 308 may each include various devices that enable sending and receiving data from external devices over networks. Examples of suitable network devices 308 include an Ethernet interface, a Wi-Fi transceiver, a cellular transceiver, a Bluetooth or BLE transceiver, UWB transceiver, or other network adapter or peripheral interconnection device that receives data from another computer or external data storage device, which can be useful for receiving large sets of audio data in an efficient manner.

The deep reinforcement active machine learning processes and systems disclosed herein can be implemented by a processing device, controller, or computer, which can include any existing programmable electronic control unit or dedicated electronic control unit. Similarly, the process can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The process can also be implemented in a software executable object. Alternatively, the process can be embodied in whole or in part using suitable hardware components, such as ASICs, FPGAs, state machines, controllers or other hardware components or devices, or a combination of hardware, software, and firmware components.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps. The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole. The phrase “consisting essentially of” limits the scope of a claim to the specified materials or steps, plus those that do not materially affect the basic and novel characteristic(s) of the claimed subject matter. The term “one or more” means “at least one” and the term “at least one” means “one or more.” The terms “one or more” and “at least one” include “plurality” as a subset.

The following application is related to the present application: U.S. patent application Ser. No. 18/768,442 filed on Jul. 10, 2024 (RBPA0488PUS), which is incorporated by reference in its entirety.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed is:

1. A method for active machine learning for audio event detection and classification, comprising:
labeling a training pool of audio samples;
training an audio event classifier to detect and categorize sounds using the labeled training pool of audio samples;
calculating one or more environment states for each of the labeled training pool of audio samples using outputs of the audio event classifier;
selecting a batch of identified audio samples from an unlabeled pool for annotation using a reinforcement learning agent;
annotating the selected batch of identified audio samples into an annotated batch of identified audio samples;
updating the labeled training pool of audio samples with the annotated batch of identified audio samples;
retraining the audio event classifier using the updated labeled training pool of audio samples to obtain a retrained audio event classifier;
calculating a reward for each audio sample in the annotated batch of identified audio samples;
updating the environment states using the retrained audio event classifier;
updating an exploration-exploitation parameter of the reinforcement learning agent;
retraining the reinforcement learning agent using the updated environment states and rewards; and
detecting an audio event and classifying the audio event in response to the retrained reinforcement learning agent.

2. The method of claim 1 wherein the audio event classifier is a deep learning model.

3. The method of claim 1 wherein the reinforcement learning agent uses a deep Q-network algorithm.

4. The method of claim 1 wherein the environment states are determined from logit outputs of the audio event classifier concatenated with softmax or sigmoid outputs of the audio event classifier.

5. The method of claim 1 wherein a reinforcement learning agent action space comprises a binary choice of requesting or not requesting an annotation for each audio sample.

6. The method of claim 5 wherein the reward is positive if the reinforcement learning agent selected an audio sample for annotation that was misclassified by the audio event classifier.

7. The method of claim 1, further comprising initializing a reinforcement learning agent policy using transfer learning from a related audio event detection task.

8. The method of claim 1 wherein the audio samples are represented as mel-frequency cepstral coefficients or log-mel spectrograms.

9. A system for active machine learning for audio event detection and classification, comprising:
a memory storing a labeled training pool of audio samples;
an audio event classifier trained using the labeled training pool;
a reinforcement learning agent configured to select a batch of audio samples from an unlabeled pool for annotation; and
a processor configured to:
calculate one or more environment states for each audio sample using outputs of the audio event classifier,
add an annotated batch of audio samples to the labeled training pool,
retrain the audio event classifier using an updated labeled training pool, calculate a reward for each audio sample in the annotated batch,
update the environment states using the retrained audio event classifier,
update an exploration-exploitation parameter of the reinforcement learning agent,
retrain the reinforcement learning agent using the updated environment states and rewards, and
detecting an audio event and classifying the audio event in response to the retrained reinforcement learning agent.

10. The system of claim 9 wherein the audio event classifier is a deep learning model.

11. The system of claim 9 wherein the reinforcement learning agent uses a deep Q-network algorithm.

12. The system of claim 9 wherein the environment states are determined from logit outputs of the audio event classifier concatenated with softmax or sigmoid outputs of the audio event classifier.

13. The system of claim 9 wherein a reinforcement learning agent action space comprises a binary choice of requesting or not requesting an annotation for each audio sample.

14. The system of claim 13 wherein the reward is positive if the reinforcement learning agent selected an audio sample for annotation that was misclassified by the audio event classifier.

15. The system of claim 9 wherein the processor is further configured to initialize a reinforcement learning agent policy using transfer learning from a related audio event detection task.

16. The system of claim 9 wherein the audio samples are represented as mel-frequency cepstral coefficients or log-mel spectrograms.

17. A non-transitory computer-readable medium storing instructions that, when executed by a processor, cause the processor to perform active learning for audio event detection and classification, by:
initializing a labeled training pool of audio samples;
training an audio event classifier using the labeled training pool;
calculating one or more environment states for each audio sample using outputs of the audio event classifier;
selecting a batch of audio samples from an unlabeled pool for annotation using a reinforcement learning agent;
annotating the selected batch of audio samples; adding an annotated batch of audio samples to the labeled training pool;
retraining the audio event classifier using an updated labeled training pool to obtain a retrained audio event classifier;
calculating a reward for each audio sample in the annotated batch;
updating the environment states using the retrained audio event classifier;
updating an exploration-exploitation parameter of the reinforcement learning agent;
retraining the reinforcement learning agent using the updated environment states and rewards; and
detecting an audio event and classifying the audio event in response to the retrained reinforcement learning agent.

18. The non-transitory computer-readable medium of claim 17 wherein the audio event classifier is a deep learning model and the reinforcement learning agent uses a deep Q-network algorithm.

19. The non-transitory computer-readable medium of claim 17 wherein the environment states are determined from logit outputs of the audio event classifier concatenated with softmax or sigmoid outputs of the audio event classifier, and a reinforcement learning agent action space comprises a binary choice of requesting or not requesting an annotation for each audio sample.

20. The non-transitory computer-readable medium of claim 17 wherein the reward is positive if the reinforcement learning agent selected an audio sample for annotation that was misclassified by the audio event classifier, and the processor is further configured to initialize a reinforcement learning agent policy using transfer learning from a related audio event detection task.
